(19) United States
(12) Patent Application Publication
(10) Pub. No.: US 2024/0321509 A1
(43) Pub. Date: Sep. 26, 2024

(54) TRANSFORMER AND METHOD OF FORMING TRANSFORMER

(71) Applicant: ABB E-mobility B.V., Delft (NL)

(72) Inventors: Filip Grecki, Rutihof (CH); Uwe Drofenik, Zurich (CH); Amin Bahmani, Erlinsbach (CH); Jedrzej Banaszczyk, Wieliczka (PL); Michal Rzepecki, Krakow (PL)

(21) Appl. No.: 18/734,720

(22) Filed: Jun. 5, 2024

Related U.S. Application Data
(63) Continuation of application No. PCT/EP2022/084596, filed on Dec. 6, 2022.

(30) Foreign Application Priority Data
Dec. 6, 2021 (EP) 21212516.5

(51) Int. Cl. H01F 27/30; H01F 27/02; H01F 27/24; H01F 41/02; H01F 41/04

(52) U.S. Cl. CPC H01F 27/306; H01F 27/24; H01F 41/0206; H01F 41/048; H01F 27/02

(57) ABSTRACT

In one embodiment, a transformer is provided. The transformer comprises a transformer core having a first core leg having a first longitudinal axis and second core leg having a second longitudinal axis; a first low voltage (LV) winding portion arranged around the first core leg, and a second LV winding portion arranged around the second core leg; a high voltage (HV) winding having a first HV winding portion arranged around the first LV winding portion, and having a second HV winding portion arranged around the second LV winding portion, the HV winding comprising a link for electrically linking the first HV winding portion with the second HV winding portion, and the HV winding comprising a first HV connector and a second HV connector for connecting the HV winding to the outside of the transformer; and a casting embedding at least the HV winding and the link.

### CROSS-REFERENCE TO RELATED APPLICATIONS

This application is a continuation of, and claims priority to, International Patent Application No. PCT/EP2022/084596, filed Dec. 6, 2022, and titled “TRANSFORMER AND METHOD OF FORMING TRANSFORMER”, which claims priority to European Patent Application No. 21212516.5, filed Dec. 6, 2021, and titled “TRANSFORMER AND METHOD OF FORMING TRANSFORMER”, each of which are hereby incorporated by reference in their entirety.

### BACKGROUND

Embodiments of the present disclosure generally relate to a transformer, particularly a medium frequency transformer (MFT), and to a method of forming a transformer.

Medium-frequency transformers (MFTs) are key components in various power-electronic systems. Examples in rail vehicles are auxiliary converters and solid-state transformers (SSTs) replacing the bulky low-frequency traction transformers. Further applications of SSTs are being considered, for example for grid integration of renewable energy sources, EV charging infrastructure, data centers, or power grids on board of ships. It is expected that SSTs will play an increasingly important role in the future.

The electric insulation constitutes a significant challenge in MFTs, because, on the one hand, operating voltages can be high (in the range of 10 kilovolt (kV) to 100 kV, particularly 50 kV to 100 kV) and on the other hand, the power of an individual MFT is rather low (in the range of several hundred kilovolt-amps (kVA)) compared to conventional low-frequency distribution and power transformers.

Some of the challenges for designing a compact and simple medium-frequency transformer (MFT) are efficient cooling of the winding, difficulties in connecting interleaved windings, and providing the bushings of the high-voltage winding at an appropriate location that satisfies both a large distance to the grounded core and a large distance to the low-voltage winding in order to avoid a breakdown.

In the state of the art, typically, two MFT coils, or winding portions, are connected in series on the high-voltage (HV) side to form a HV winding, and two MFT coils, or winding portions, are connected in parallel on the low voltage (LV) side to form a LV winding. The connection of the HV winding portions makes the manufacturing and operation of the MFT less reliable: There is a need for HV bushings to lead the ends of the HV winding portions in and out, since the HV winding portions are electrically in the vicinity of the ground potential, due to the proximity thereof to e.g., the magnetic MFT core and other surrounding components. This impacts the dielectric properties of the transformer. Moreover, the connection between the HV winding portions has to be done manually, e.g., during assembly of the transformer. In this manual operation, special attention has to be paid to achieve good electrical properties of the connection, such as low resistance, a proper connection of the litz strands that the HV winding portions are made from, and keeping the proper transposition of the parallel wires. Additionally, the HV winding portions being externally connected, i.e., at a distance from the transformer core, form a loop in this external portion. Any metal objects that inadvertently enter this loop will be an object of induction heating, potentially leading to hazards such as fire, equipment damage and a potentially dangerous situation of personnel.

Accordingly, there is a demand for a transformer, particularly MFT, which overcome at least some of the problems of the state of the art or with which negative effects of conventional transformers can at least be reduced.

### BRIEF DESCRIPTION

In light of the above, a transformer according to claim 1 is provided. Furthermore, a method of forming a transformer according to claim 9 is provided. Further aspects, advantages, and features are apparent from the dependent claims, the description, and the accompanying drawings.

For example, according to an aspect of the present disclosure, a transformer is provided. The transformer is particularly an MFT transformer. The transformer includes a transformer core. The transformer core has a first core leg and a second core leg. The first core leg has, or extends along, a first longitudinal axis. The second core leg has, or extends along, a second longitudinal axis. The transformer further includes a first LV winding portion and a second LV winding portion. The first LV winding portion is arranged around the first core leg. The second LV winding portion is arranged around the second core leg. The transformer further includes a HV winding. The HV winding has a first HV winding portion and a second HV winding portion. The first HV winding portion is arranged around the first LV winding portion. In other words: The first HV winding portion is arranged, through intermediation of the first LV winding portion, around the first core leg. The second HV winding portion is arranged around the second LV winding portion. In other words: The second HV winding portion is arranged, through intermediation of the second LV winding portion, around the second core leg. The HV winding comprises a link, the link serving for electrically linking, or connecting, the first HV winding portion and the second HV winding portion. The HV winding further comprises a first connector and a second connector, the first and second connectors serving for providing a connection of the HV winding to the outside of the transformer. The transformer further comprises a casting. The casting embeds at least the HV winding and the link.

High voltage, as used herein, includes e.g., a voltage in a range above 1 kV or above 1.2 kV, such as, without limitation, 1.5 kV. Low voltage, as used herein, includes e.g., a voltage in a range below 1 kV or below 500 V, such as, without limitation, 400 V. High voltage winding, as used herein, refers to the winding at which, in an operation of the transformer, the high voltage is present, e.g, to which the high voltage is applied. In some examples, the high voltage winding may be referred to as primary winding. Low voltage winding, as used herein, refers to the winding at which, in an operation of the transformer, the low voltage is present, e.g., at which the low voltage is extracted. Medium frequency, as used herein, includes a frequency that is higher than a standard power grid frequency, e.g., higher than 50 hertz (Hz) or 60 Hz, e.g., by a factor of 2 or more, typically by a factor of 10 or more. In some examples, without limitation, the medium frequency is higher than 500 Hz, such as 10 kilohertz (kHz).

Embedding at least the HV winding and the link in the casting, as used herein, refers to covering, from all sides, at least a major part of the HV winding and substantially the entirety of the link in the casting material, potentially—as for the region in which the link is located—except for a dielectrically negligible portion or dielectrically negligible portions such as a minor slit, e.g., a minute slit between adjacent components when the casting is formed of multiple casting portions etc. The major part of the HV winding may optionally include substantially the entire HV winding, potentially except for a dielectrically negligible portion or dielectrically negligible portions such as a minor slit, e.g., a minute slit between adjacent components when the casting is formed of multiple casting portions etc.

A connection of the HV winding to the outside, as used herein, is used for applying the high voltage to the HV winding or extracting the high voltage from the HV winding. The outside, as used herein, may include any equipment external from the transformer, such as, but not limited to, a connecting conductor, a connecting wire, a bus bar etc. Typically, an imaginary interface between a HV connectors and the outside is defined as a point at which the material and/or constructive configuration of the HV winding ends, e.g., an end of a litz wire used as the conductor in the HV winding etc.

The respective winding portion being provided around a core leg, as used herein, typically refers to an arrangement in which the respective winding portion is located at a certain distance to the respective core leg such as to surround the respective core leg. For example, the winding portion is wound, to form a coil made out of turns, around the core leg at the certain distance. In an example, the certain distance in the case of the LV winding portions is minute, such as less than 5 millimeters (mm) or less than 1 mm.

In particular examples, the first and second longitudinal axes of the first and second core legs define a core plane, that is both the first longitudinal axis and the second longitudinal axis are within the core plane. A distance of the link to the core plane, e.g., the average distance of the closest portions of the link to the core plane, is not further away from the core plane than the HV winding portions and/or the imaginary interface between the HV connectors and the outside, as discussed above. Furthermore, in particular examples, the length of the link is less than the distance between the first longitudinal axis and the second longitudinal axis.

Accordingly, beneficially the transformer provided herein exhibits the effect that the connection, or link, of the HV winding portions to obtain the HV winding does not need an error-prone external assembly and thus no additional bushings for establishing the link in a respective assembly operation, which may help to improve the electrical properties of the transformer and a reduction of the box volume of the transformer. For example, the volume reduction may be as high as 30% compared to a traditional MFT. In addition, in the transformer provided herein, the HV connectors, or HV terminals, may be located at a position in which the electrical distance to ground potential components is extended.

In embodiments, at least one of the first HV connector and the second HV connector is located in a middle region of the respective HV winding portion. The respective HV winding portion is the HV winding portion to which the HV connector belongs. Optionally, the first and second HV connectors are both arranged in a middle region of the respective HV winding portion. The respective HV winding portion, as used herein, is that one of the HV winding portions that the connector belongs to. A middle region, as used herein, is a continuous region including the half-way section, perpendicular to the respective one of the first and second longitudinal axes 11, 12, between one axial end of the respective HV winding portion and the other axial end of the respective HV winding portion. In an example, the middle region includes more than 1% and less than 20%, optionally more than 2% and less than 10%, and typically about 5% of the continuous region including the half-way section.

In embodiments, the link extends substantially perpendicular to the first and second longitudinal axes at an axial end of the HV winding. The axial end of the HV winding is an end of the respective HV winding portion at which the conductor forming the HV winding portion, e.g., a conductor wire such as a litz wire, ends or at which the conductor ceases to contribute to the coil properties of the winding in a substantial manner. Substantially perpendicular includes a deviation from perfect perpendicularity of up to 5° or up to 10°.

In embodiments, the casting comprises a single casting that embeds the link. Preferably, the single casting embeds, in addition to the link, the first and second HV winding portions. A single casting is simple to manufacture and provides a high degree of mechanical stability to the constituent elements of the transformer.

In embodiments, the casting comprises a first HV casting and a second HV casting. The first HV casting embeds the first HV winding portion. The second HV casting embeds the second HV winding portion. The first HV casting and the second HV casting together embed substantially the link. That is, the first and second HV castings, taken as a whole although they may not be mechanically connected, e.g., although they may not be formed as one piece, embed substantially the entire link. Embedding substantially the entire link, as used herein includes covering substantially the entirety of the link in the casting material, potentially except a dielectrically negligible portion or dielectrically negligible portions such as a minor slit. Multiple HV castings provide a higher degree of flexibility in manufacturing and assembly; yet the degree of stability for the constituent elements of the transformer is high.

In embodiments, the casting comprises at least one HV casting and at least one LV casting. The HV casting(s) embed(s) the HV winding and the link. The LV casting(s) embed(s) one or both of the first LV winding portion and the second LV winding portion. Optionally, a mechanical connection between the first casting and the second casting is provided. Separate castings for the HV and the LV components may be arranged such that the cooling performance of the transformer is improved, such as by arranging them at a distance from each other, forming a gap in between, and having a cooling fluid such as air ventilate or circulate through the gap.

In embodiments, the HV winding is integrally formed including the link. That is, the HV winding and the link are formed as one piece, i.e., a single piece, e.g., without cutting the wire. That is, the link 230 can be the HV winding conductor itself, e.g., a coil wire such as a litz wire, without being cut. In such a one-piece configuration, no error-prone connection of the windings is necessary.

In another example, according to an aspect of the present disclosure, a method of forming a transformer is provided. The transformer is particularly an MFT transformer, such as a solid-state transformer. The method comprises providing a transformer core. The transformer core includes a first core leg and a second core leg. The first core leg has, or extends along, first longitudinal axis. The second core leg has, or extends along, a second longitudinal axis. The method further comprises providing a first low voltage, LV, winding that is to be arranged around the first core leg in such a manner that the first LV winding extends in the direction of the first longitudinal axis. The method further comprises providing a second low voltage, LV, winding that is to be arranged around the second core leg in such a manner that the second LV winding extends in the direction of the second longitudinal axis. The method further comprises providing a high voltage, HV, winding. The HV winding includes a first HV winding portion that is to be arranged around the first LV winding portion and thereby around the first longitudinal axis. The HV winding further includes a second HV winding portion that is to be arranged around the second LV winding portion and thereby around the second longitudinal axis. The HV winding further includes a link. The link is for linking the first HV winding portion with the second HV winding portion. THE HV winding further includes a first HV connector and a second HV connector. The first and second HV connectors are for connecting the HV winding to the outside of the transformer. The method further comprises performing a casting process in which at least the HV winding and substantially the entire link are embedded. In the casting process, a first lead-out section for leading the first HV connector out of the casting and a second lead-out section for leading the second HV connector out of the casting are formed. The method further comprises assembling the transformer.

In embodiments pertaining to the method, the first HV winding portion of the HV winding and the second HV winding portion of the HV winding are each provided as separate parts. Then, the first HV winding portion and the second HV winding portion are connected to obtain the link.

In embodiments pertaining to the method, the first HV winding portion of the HV winding and the second HV winding portion of the HV winding are provided as a common part that includes the link. That is, the first HV winding portion of the HV winding and the second HV winding portion of the HV winding are continuously provided without the need to connect them afterwards in order to obtain the link.

In embodiments pertaining to the method, performing the casting process includes, after the link is obtained, providing a first casting mold and a second casting mold. The first casting mold is for embedding the first HV winding portion of the HV winding. The second casting mold is for embedding the second HV winding portion of the HV winding. In the embodiment, performing the casting process further comprises using the first and second casting molds to obtain the casting that embeds the first and second HV winding portions to form the HV winding and substantially the entire link.

In embodiments pertaining to the method, performing the casting process comprises embedding all of the HV winding and the first LV winding and the second LV winding in a single casting.

In embodiments pertaining to the method, performing the casting process comprises embedding the HV winding in a HV casting and embedding one or both of the first LV winding and the second LV winding in at least one LV casting. For example, the HV winding is embedded in a HV casting, the first LV winding is embedded in a first LV casting, and the second LV winding is embedded in a second LV casting. Alternatively, the HV winding is embedded in a HV casting, and the first and second LV windings are embedded in a common LV casting.

In embodiments pertaining to the method, the method further comprises arranging at least one of the first HV connector and the second HV connector in a middle region of the respective HV winding portion. Optionally, the first and second HV connectors are both arranged in a middle region of the respective HV winding portion. The respective HV winding portion, as used herein, is that one of the HV winding portions that the connector belongs to. In an example, the middle region includes less than 20% of the region between one axial end of the respective HV winding portion and the other axial end of the respective HV winding portion.

### BRIEF DESCRIPTION OF THE DRAWINGS

So that the manner in which the above recited features of the present disclosure can be understood in detail, a more particular description of the disclosure, briefly summarized above, may be is given by reference to embodiments. The accompanying drawings relate to embodiments of the disclosure and are described in the following:

FIG. 1 shows a schematic perspective view of a transformer according to an embodiment;

FIG. 2 shows a perspective view of a part of a transformer core including transformer core legs, LV winding portions arranged around the legs, and a HV winding including a link and arranged around the LV winding portions;

FIG. 3 shows a perspective view similar to the one in FIG. 2, including a casting for embedding the HV winding and the link;

FIG. 4 shows a single casting for embedding the LV winding portions, the HV winding and the link; and

FIG. 5 shows a single casting for embedding the LV winding portions and another single casting for embedding the HV winding and the link.

### DETAILED DESCRIPTION

Reference will now be made in detail to the various embodiments, one or more examples of which are illustrated in each figure. Each example is provided by way of explanation and is not meant as a limitation. For example, features illustrated or described as part of one embodiment can be used on or in conjunction with any other embodiment to yield yet a further embodiment. It is intended that the present disclosure includes such modifications and variations.

Within the following description of the drawings, the same reference numbers refer to the same or to similar components. Generally, only the differences with respect to the individual embodiments are described. Unless specified otherwise, the description of a part or aspect in one embodiment can apply to a corresponding part or aspect in another embodiment as well.

Throughout the disclosure, the term “high voltage” may be abbreviated as “HV”, and the term “low voltage” may be abbreviated as “LV”. In relation to the transformer and its constituent elements, HV relates to a high electrical potential and/or its electrical environment, and LV relates to a low electrical potential and/or its electrical environment. That is, an indicative value, e.g., an absolute value or a root mean square (RMS) value, of the high electrical potential is higher than an indicative value, e.g., an absolute value or an RMS value, of the low electrical potential.

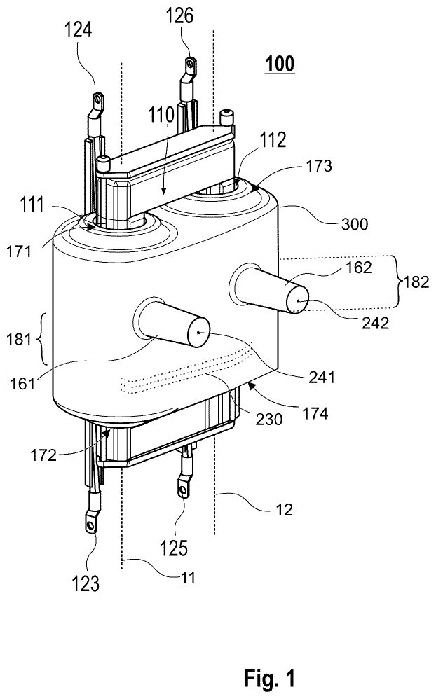

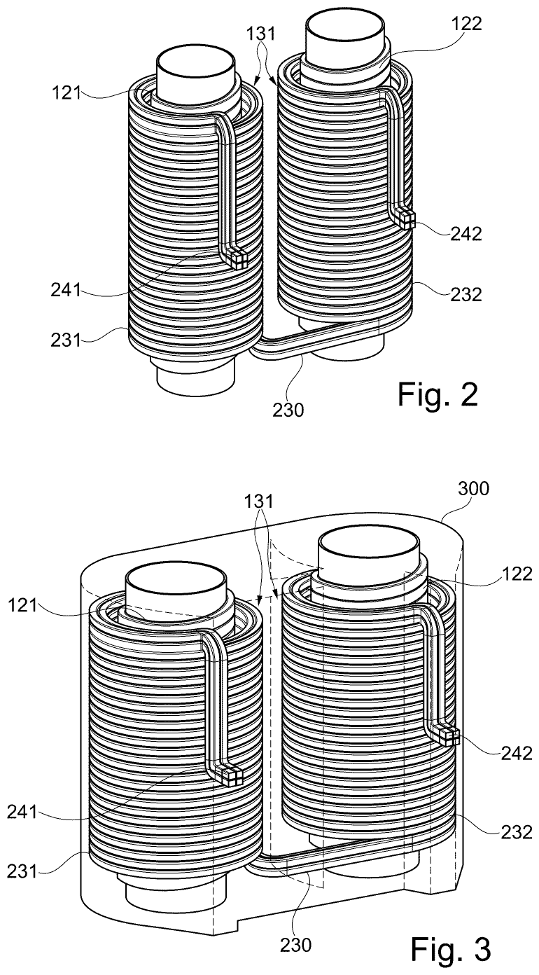

With reference to FIGS. 1 and 2, a transformer 100 according to an embodiment is described. In particular, the transformer 100 as described herein can be a medium frequency transformer. FIG. 1 shows an exterior of the transformer 100 in a perspective view, and FIG. 2 shows an interior part of the transformer 100, namely a part of a transformer core 110 including transformer core legs 111, 112. The legs 111, 112 are referred to as a first core leg 111 and a second core leg 112. The first core leg has a first longitudinal axis 11. That is, the first core leg extends along the first longitudinal axis 11. The second core leg 112 has a second longitudinal axis 12. That is, the second core leg extends along the second longitudinal axis 12. Optionally, as shown in FIG. 1, the first and second longitudinal axes 11, 12 are substantially parallel to each other. The term “substantially parallel” includes parallel within a certain deviation angle D from exact parallelism, such as D≤±10°, particularly D≤±5°, more particularly D≤±2°.

In addition, as shown in FIG. 2, the transformer includes a first LV winding portion 121 and a second LV winding portion 122. The first LV winding portion 121 and the second LV winding portion 122 together form a LV winding. The first LV winding portion 121 is arranged, i.e., directly or indirectly wound, around the first core leg 111. The second LV winding portion 122 is arranged, i.e., directly or indirectly wound, around the second core leg 112.

The transformer 100 further includes a HV winding 131. The HV winding 131 includes a first HV winding portion 231 and a second HV winding portion 232. The first HV winding portion 231 has an electrical connection to the second HV winding portion 232, referred to herein as a link 230. In FIG. 1, the link 230 is shown by a dotted line as it is embedded in a casting 300, 301, as described further below. The link is directly visible in FIG. 2.

In particular, in some embodiments described herein, the first HV winding portion 231 and the second HV winding portion 232 may be integrally formed, wherein the connecting portion between the first HV winding portion 231 and the second HV winding portion 232 of the integrally formed HV winding 131 forms the link 230. That is, according to the embodiment, the link 230 is continuous with the first HV winding portion 231 and the second HV winding portion 232, i.e., the entire HV winding 131 is formed from a continuous conductor wire without any joining, e.g., soldering.

The link 230 is the element that connects the first HV winding portion 231 and the second HV winding portion 232. The first HV winding portion 231 and the second HV winding portion 232 each have their winding ends connected with the respective ends of the link 230, or they are integrally formed with the ends of the link 230. The winding ends of the first and second HV winding portions 231, 232 are defined as where the extension direction of the conductor that forms the respective winding portion transitions from the circumferential direction around the respective axis 11, 12 to the direction towards the other HV winding portion. Typically, the length of the link 230, i.e., the end-to-end dimension of the link 230, is less than the distance between the first longitudinal axis 11 and the second longitudinal axis 12.

The LV winding portions 121, 122 each form a coil, exposed, or connectible, to the outside via LV connectors 123, 124, 125, 126, as a LV side of the transformer 100. The HV winding portions 231, 232 each form a coil, exposed, or connectible, to the outside via first and second HV connectors 241, 242, as a HV side of the transformer 100. The link 230 and the first and second HV connectors 241, 242 are electrically connected to electrically opposite ends of the first or second HV winding portion 231, 232, respectively. As shown in FIG. 1, the first HV connector 241 is led through a bushing 161, and the second HV connector 242 is led through a bushing 162. The bushings 161, 162 are typically made of an insulating material, such as a resin.

In the embodiment shown in FIGS. 1 and 2, the first and second longitudinal axes 11, 12 of the first and second core legs 111, 112 define a core plane (not shown), that is both the first longitudinal axis 11 and the second longitudinal axis 12 are within the core plane. A distance of the link 230 to the core plane, e.g., the average distance of the closest portions of the link 230 to the core plane, is not further away from the core plane than the HV winding portions 231, 232 and/or a point between at least one of the HV connectors 241, 242 and the outside. In other words: the link 230 is close to the core legs, and there is no need to lead any further connectors out that only serve the purpose of establishing the series connection of the HV winding portions 231, 232, as in the prior art.

In the embodiment shown in FIGS. 1 and 2, the first HV winding portion 231 is arranged around the first LV winding portion 121. Thereby, the first HV winding portion 231 is arranged around the first core leg 111, but with a larger coil diameter than the first LV winding portion 121. Likewise, the second HV winding portion 232 is arranged around the second LV winding portion 122. Thereby, the second HV winding portion 232 is arranged around the second core leg 112, but with a larger coil diameter than the second LV winding portion 122.

When an alternating voltage is applied to the LV side, the transformer 100 transforms it to a higher voltage on the HV side, according to the winding ratio. Similarly, when an alternating voltage is applied to the HV side, the transformer 100 transforms it to a lower voltage on the LV side, according to the winding ratio. The winding ratio depends on the relation of the number of turns of the HV winding 131 to the number of turns of the LV winding. In the typical case of the transformer 100 being a solid state medium frequency transformer, MFT, the alternating voltage has a frequency of much more than a design frequency of a typical distribution transformer that is typically directly the power grid frequency, e.g., 50 Hz or 60 Hz. In a non-limiting example, the MFT is designed for a frequency of about 10 kHz. The operating frequency may be below 10 kHz, such as less than 5 kHz or less than 2 kHz, or above 10 kHz, such as more than 15 kHz or more than 20 kHz. In the particular non-limiting example, the MFT can be designed for about 200 kVA with a HV direct current (DC) insulation of 50 kV, a root mean square value of the alternating voltage (ACrms) of about 70 kV, and a lightning impulse (LI) of about 150 kV.

In the embodiments described herein, a casting 300, 301 is provided. The casting 300, 301 comprises an insulation material. Specifically, the casting 300, 301 may be made partially or entirely of the insulation material. Insulation material, as used herein, refers to a material whose electrical conductivity is sufficiently low such that any adverse effects on the electrical insulation properties of the transformer 100 are suppressed to an acceptable extent, e.g., substantially eliminated. Insulation material, as used herein, further includes both a substantially homogenous material or a mixture of materials. In a particular example, the casting 300, 301 comprises an insulating resin, such as, but not limited to, an epoxy resin. Optionally, in the particular example, the casting 300, 301 is substantially entirely made of the insulating resin.

In the embodiments described herein, the casting 300, 301 embeds at least the HV winding 131 and the link 230. The transformer 100 thus has the link 230 inside the casting 300, 301, eliminating the need for an error-prone external assembly. No additional bushings for connecting HV winding portions 231, 232 to obtain the HV winding 131 are necessary, thus improving the electrical properties of the transformer and a reducing the box volume of the transformer 100. Also, no induction loop is formed external of the casting 300, 301. Thus, foreign matter such as a metallic object etc. is prevented from entering the induction loop and thus from being heated in the induction loop.

As can be seen in FIGS. 1 and 2, in the embodiment, the HV connectors 231, 232, or HV terminals, are located at a position in which the electrical distance to components on a different electrical potential is extended. It is beneficial for the HV connectors 231, 232 to be located at a position having a large distance both to the LV connectors 123, 124, 125, 126 and the core legs 111, 112. The first HV winding portion 231 has a first axial end 171 and an opposite second axial end 172. Likewise, the second HV winding portion 232 has a first axial end 173 and an opposite second axial end 174. At the axial ends 171, 172, 173, 174, the conductor wire forming the HV winding portion 231, 232, e.g., the litz wire, ceases to contribute to the coil properties of the winding in a substantial manner. Between the first and second axial ends 171, 172 of the first HV winding portion 231, a first middle region 181 is defined, the first middle region 181 including a region half-way between the first and second axial ends 171, 172. Likewise, between the first and second axial ends 173, 174 of the second HV winding portion 232, a second middle region 182 is defined, the second middle region 182 including a region half-way between the first and second axial ends 173, 174. The first HV connector is arranged in the first middle region 181. Likewise, the second HV connector is arranged in the second middle region 182. Each of the middle regions 181, 182 is a narrow region. Typically, the first and second middle regions each include more than 1% and less than 20%, optionally more than 2% and less than 10%, and typically about 5% of a continuous region including the region half-way between the respective axial ends 171, 172 or 173, 174. In this, way, the HV connectors 241, 242 are located in the middle of the casting 300, 301 body, thus minimizing the dimensions of the bushings 161, 162 or potentially eliminating the need for the bushings 161, 162.

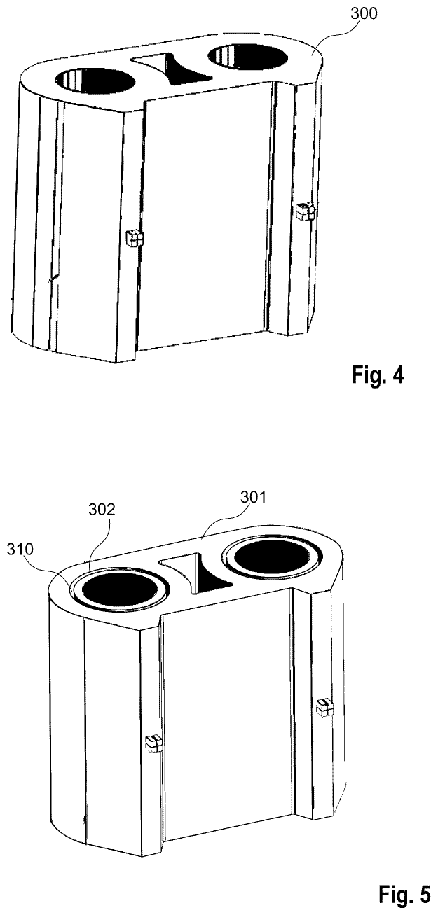

FIG. 3 shows a perspective view of a part of the transformer 100, similar to the one in FIG. 2. In FIG. 3, the casting 300 for embedding the HV winding 131 and the link 230 is shown. As can be seen from FIG. 3, the casting 300 is a single casting embedding substantially the entirety of the windings, that is the HV winding 131, the LV winding portions 121, 122, and the link 230. That is, in the embodiment shown in FIG. 3, the casting 300 is a single casting for accommodating, or embedding, both the HV winding 131, the LV winding portions 121, 122, and the link 230. The casting 300 is, for example, formed integrally from one piece of insulating material, such as resin. FIG. 4 shows the single casting 300 separately. The embodiment in FIGS. 3 and 4 is a simple, cost-effective solution.

FIG. 5 shows an alternative embodiment. In FIG. 5, a composite configuration is assumed, in which one single casting 301 embeds the HV winding 131 and the link 230 together, and another one single casting 302 embeds the LV winding portions 121, 122. The castings 301, 302 are arranged such that a gap 310 is present therebetween. In this manner, the cooling performance for cooling the coils, e.g., via air circulation, is improved over the embodiment of FIGS. 3 and 4.

While the foregoing is directed to embodiments, other and further embodiments may be devised without departing from the basic scope, and the scope is determined by the claims that follow.

1. A transformer, comprising:
a transformer core having a first core leg having a first longitudinal axis and second core leg having a second longitudinal axis;
a first low voltage (LV) winding portion arranged around the first core leg, and a second LV winding portion arranged around the second core leg;
a high voltage (HV) winding having a first HV winding portion arranged around the first LV winding portion, and having a second HV winding portion arranged around the second LV winding portion, the HV winding comprising a link for electrically linking the first HV winding portion with the second HV winding portion, and the HV winding comprising a first HV connector and a second HV connector for connecting the HV winding to the outside of the transformer; and
a casting embedding at least the HV winding and the link.

2. The transformer according to claim 1, wherein at least one of the first HV connector and the second HV connector is located in a middle region of the respective HV winding portion.

3. The transformer according to claim 1, wherein the link extends perpendicular to the first and second longitudinal axes at an axial end of the HV winding.

4. The transformer according to claim 1, wherein the casting comprises a single casting that embeds the link.

5. The transformer according to claim 1, wherein the casting comprises a first HV casting that embeds the first HV winding portion, wherein the casting comprises a second HV casting that embeds the second HV winding portion, and wherein the first HV casting and the second HV casting together embed the entire link (230).

6. The transformer according to claim 1, wherein the casting comprises at least one HV casting that embeds the HV winding and the link, and wherein the casting further comprises at least one LV casting that embeds one or both of the first LV winding portion and the second LV winding portion.

7. The transformer according to claim 6, further comprising a mechanical connection between the at least one HV casting and the at least one LV casting.

8. The transformer according to any one of the preceding claims, wherein the HV winding is integrally formed including the link.

9. A method of forming a transformer, the method comprising:
providing a transformer core having a first core leg having a first longitudinal axis and second core leg having a second longitudinal axis;
providing a first low voltage LV) winding to be arranged around the first core leg such as to extend in a direction of the first longitudinal axis, and a second LV winding to be arranged around the second core leg such as to extend in a direction of the second longitudinal axis;
providing a high voltage (HV) winding having a first HV winding portion to be arranged around the first LV winding and having a second HV winding portion to be arranged around the second LV winding, the HV winding comprising a link for linking the first HV winding portion with the second HV winding portion, and the HV winding comprising a first HV connector and a second HV connector for connecting the HV winding to the outside of the transformer;
performing a casting process to obtain a casting in which at least the HV winding and the entire link are embedded, wherein in the casting process, a first lead-out section for leading the first HV connector out of the casting and a second lead-out section for leading the second HV connector out of the casting are formed; and
assembling the transformer using the casting.

10. The method according to claim 9, wherein providing the HV winding comprises:
providing the first HV winding portion of the HV winding and providing the second HV winding portion of the HV winding as separate parts; and
connecting the first HV winding portion and the second HV winding portion to obtain the link.

11. The method according to claim 9, wherein providing the HV winding comprises:
providing the first HV winding portion of the HV winding and providing the second HV winding portion of the HV winding as a common part including the link.

12. The method according to claim 9, wherein performing the casting process comprises:
after the link is obtained: providing a first casting mold for embedding the first HV winding portion of the HV winding and providing a second casting mold for embedding the second HV winding portion of the HV winding; and
performing the casting process using the first and second casting molds to obtain the casting embedding the first and second HV winding portions to form the HV winding, and the entire link.

13. The method according to claim 9, wherein performing the casting process comprises embedding both the HV winding and the first LV winding and the second LV winding in a single casting.

14. The method according to claim 9, wherein performing the casting process comprises embedding the HV winding in a HV casting and embedding one or both of the first LV winding portion and the second LV winding portion in at least one LV casting.

15. The method according to claim 9, further comprising:
arranging at least one of the first HV connector and the second HV connector in a middle region of the respective HV winding portion.

16. The transformer according to claim 1, wherein both the first HV connector and the second HV connector are located in a middle region of the respective HV winding portion.

17. The transformer according to claim 1, wherein at least one of the first HV connector and the second HV connector is located in a middle region of the respective HV winding portion, and wherein the link extends perpendicular to the first and second longitudinal axes at an axial end of the HV winding.

18. The transformer according to claim 1, wherein both the first HV connector and the second HV connector are located in a middle region of the respective HV winding portion, and wherein the link extends perpendicular to the first and second longitudinal axes at an axial end of the HV winding.

19. The transformer according to claim 1, wherein the casting comprises a single casting that embeds the link and the first and second HV winding portions.

20. The transformer according to claim 1, wherein at least one of the first HV connector and the second HV connector is located in a middle region of the respective HV winding portion, and wherein the link extends perpendicular to the first and second longitudinal axes at an axial end of the HV winding, and wherein the HV winding is integrally formed including the link.
